(19) United States
(12) Patent Application Publication
(10) Pub. No.: US 2002/0147655 A1
(43) Pub. Date: Oct. 10, 2002

(54) Method of exchanging goods by an auction

(76) Inventor: Mustafa Erhan Say, Istanbul (TR)

Correspondence Address: Cary S. Kappel, 14th Floor, 485 Seventh Avenue, New York, NY, 10018, US

(21) Appl. No.: 09/811,711

(22) Filed: Mar. 19, 2001

(51) Int. Cl. G06F 17/60

(52) U.S. Cl. 705/26

(57) ABSTRACT

A computerized system and method for auctioning products or services is provided which maintains a set of members, the members including a plurality of buyers of products and/or services and a plurality of sellers of products and/or services. The system supports buyer auctions (in which a buyer solicits bids from a plurality of sellers) and seller auctions (in which sellers solicit bids from a plurality of buyers). The system initiates an auction in response to a request from one of the plurality of members. The request includes product/service specifications for a product/service which the initiator wishes to sell (or in the case of a buyer auction, which the buyer wishes to purchase), a set of alternative payment specifications acceptable to the initiator, a set of alternative shipment term specifications acceptable to the initiator, and an auction specification. The product specifications may, for example, include one or more of a product name, a product grade, packing specifications, product specifications, product quality, product quantity, origin of goods, and destination of goods. The set of payment specifications may, for example, include one or more of a preferred payment term, a set of preferred banks, a preferred set of banks for negotiation, an earliest date to open, a latest date to open, and an auction currency. The set of alternative shipment specifications in turn, may include one or more of an earliest shipment date, a latest shipment date, a preferred shipment term. The auction specifications may, for example, include an identification of sellers (or buyers) authorized to bid.

### FIELD OF THE INVENTION

The present invention relates to a method of buying and selling goods. Specifically, the present invention relates to buying and selling goods in an auction transaction.

### BACKGROUND OF THE INVENTION

The Internet, a network connecting many computer networks and based on a common addressing system and communications protocol called TCP/IP (Transmission Control Protocol/Internet Protocol), has revolutionized the computer and communications world like nothing before. From its creation in 1983 it grew rapidly beyond its largely academic origin into an increasingly commercial and popular medium.

By the mid-1990s the Internet connected millions of computers throughout the world. Many commercial computer network and data services also provided at least indirect connection to the Internet.

The original uses of the Internet were electronic mail (commonly called “E-mail”), file transfer (using ftp, or file transfer protocol), bulletin boards and newsgroups, and remote computer access (telnet). The World Wide Web, which enables simple and intuitive navigation of Internet sites through a graphical interface, expanded dramatically during the 1990s to become the most important component of the Internet.

The Internet had its origin in a U.S. Department of Defense program called ARPANET Advanced Research Projects Agency Network), established in 1969 to provide a secure and survivable communications network for organizations engaged in defense-related research. Researchers and academics in other fields began to make use of the network, and at length the National Science Foundation (NSF), which had created a similar and parallel network called NSFNet, took over much of the TCP/IP technology from ARPANET and established a distributed network of networks capable of handling far greater traffic. NSF continues to maintain the backbone of the network (which carries data at a rate of 45 million bits per second), but Internet protocol development is governed by the Internet Architecture Board, and the InterNIC (Internet Network Information Center) administers the naming of computers and networks.

Amateur radio, cable television wires, spread spectrum radio, satellite, and fibre optics all have been used to deliver Internet services. Networked games, networked monetary transactions, and virtual museums are among applications being developed that both extend the network's utility and test the limits of its technology.

In recent years, it has also become increasingly common to have auctions over the Internet, with the buyer using credit cards or other forms of credit to purchase the goods auctioned.

### SUMMARY OF THE INVENTION

In accordance with a first embodiment of the present invention, a computerized system and method for auctioning products or services is provided which maintains a set of members, the members including a plurality of buyers of products and/or services and a plurality of sellers of products and/or services. The system supports buyer auctions (in which a buyer solicits bids from a plurality of sellers) and seller auctions (in which sellers solicit bids from a plurality of buyers).

The system initiates a seller auction in response to a request from one of the plurality of sellers. The request includes product/service specifications for a product/service which the seller wishes to sell, a set of alternative payment specifications acceptable to the seller, a set of alternative shipment term specifications acceptable to the seller, and an auction specification. The product specifications may, for example, include one or more of a product name, a product grade, packing specifications, product specifications, product quality, product quantity, origin of goods, and destination of goods. The set of payment specifications may, for example, include one or more of a preferred payment term, a set of preferred banks, a preferred set of banks for negotiation, an earliest date to open, a latest date to open, and an auction currency. The set of alternative shipment specifications in turn, may include one or more of an earliest shipment date, a latest shipment date, a preferred shipment term. The auction specifications may, for example, include an identification of sellers authorized to bid.

In response to the initiation of the seller auction, the system receives one or more bids from a corresponding one or more of the plurality of buyers. Each bid identifies one of the set of alternative payment specifications acceptable to the seller, one of the set of alternative shipment specifications acceptable to the seller, and a desired price for the product/service identified by the product/service specifications. In this regard, it should noted although the term “alternative” specifications is used herein, such “alternative” specifications include the specification of only a single alternative (e.g., payment must be in U.S. dollars), or a range (e.g., delivery must be between January 1 and February 1). The bid identifies one of the set of alternative specifications by submitting information which conforms to the specification (e.g., payment in U.S. dollars, or delivery on January 15).

In any event, for each of the one or more bids, the system verifies that the bid is from an authorized one of the plurality of buyers based upon the auction specification. The system then receives, from the seller, either an acceptance of one of the authorized bids or a rejection of all authorized bids.

The system initiates a buyer auction in response to a request from one of the plurality of buyers. This request similarly includes product/service specifications for a product/service which the buyer wishes to purchase, a set of alternative payment specifications acceptable to the buyer, a set of alternative shipment term specifications acceptable to the buyer, and an auction specification. In response to the initiation of the buyer auction, the system receives one or more bids from a corresponding one or more of the plurality of sellers, each bid identifying one of the set of alternative payment specifications acceptable to the buyer, one of the set of alternative shipment specifications acceptable to the buyer, and a desired price for the product/service identified by the product/service specifications. Then, for each of the one or more bids, the system verifies that the bid is from an authorized one of the plurality of sellers based upon the auction specification. The system then receives, from the buyer, either an acceptance of one of the authorized bids or a rejection of all authorized bids.

In accordance with a second embodiment of the present invention, a computerized system and method for auctioning products or services is provided comprising the steps of initiating an auction in response to a request from an auctioneer and receiving one or more bides from corresponding one or more bidders. The request may, for example, include product/service specifications for a product/service which the auctioneer wishes to sell or buy, a set of alternative payment specifications acceptable to the auctioneer, a set of alternative shipment term specifications acceptable to the auctioneer. The bids, in turn, may identify one of the set of alternative payment specifications acceptable to the auctioneer, one of the set of alternative shipment specifications acceptable to the auctioneer, and a desired price for the product/service identified by the product/service specifications. These sets of alternative specifications can be provided in the same manner as described above with respect to the first embodiment.

In any event, a plurality of the bidders is then selected to form a final bidders set. The final bidders set may be selected by the auctioneer, or may be automatically selected by the system. The system could, for example, select the three highest bidders as the final bidder set. Each one of bidders of the final bidders is then, in turn, designated as the select bidder until either i) an agreement is reached between a select bidder and the auctioneer, or ii) all of the bids have been rejected from all of the final bidders. In this regard, time limits could be set which limit the time in which the auctioneer can negotiate with each final bidder, or which set an expiration time on a bidder's bid. The select bidder can send one or more bidder bids to the auctioneer, and the auctioneer can send one or more auctioneer bids to the select bidder. If an agreement is reached on a current bid between the select bidder and the auctioneer, the auction terminates. If, however, the negotiation between the select bidder and the auctioneer terminates without agreement (e.g., the time limit for negotiation expired, or one party breaks off negotiations), then the next bidder in the set of final bidders becomes the select bidder, and the process is repeated.

In accordance with further aspects of the above embodiments, the system provides a qualification (or performance) rating for each buyer, seller, auctioneer, or bidder which is based upon information provided by other buyers or sellers. In this regard, a seller's qualification rating is preferably based upon rating information provided by buyers, and a buyer's qualification rating is preferably based upon rating information provided by sellers.

In accordance with other aspects of the above embodiments, the system includes two types of buyer entities (BUYER an TRADER) and two types of seller entities (SUPPLIER and DISTRIBUTOR). The BUYER is defined as a member who purchases goods through the system for their own consumption and not for resale. The SUPPLIER is a member who produces goods traded on the system or an affiliated office associated with the producer member. Also included in the definition of the SUPPLIER is any individual or company that has authority to act as an exclusive agent for the producer member or affiliated office. The TRADER is a buyer who re-sells goods produced or sold by the suppliers on an ex-proforma basis without acting as an exclusive agent. The DISTRIBUTER is any member who re-sells goods produced/sold by the suppliers on an ex-inventory basis. In accordance with this feature, BUYERS and DISTRIBUTORS can initiate buyer auctions, SUPPLIERS can initiate seller auctions, DISTRIBUTORS, SUPPLIERS, and TRADERS can participate in buyer auctions, and DISTRIBUTORS, TRADERS, and BUYERS can participate in seller auctions.

In accordance with further aspects of the above embodiments of the present invention, the alternative payment specifications may include two or more of a payment by letter of credit term, cash against documents term, cash against goods term, open account term, wire transfer term, check term, a cash term, and an auction currency term; the product/service specifications may include two or more of a packed/bagged term, packed/drummed term, bulk term, palletized term, non-palletized term, and user defined packing term; and the product/service specifications may include two or more of an open to all countries term, all countries except a selected one term, and only the selected countries term.

In accordance with still other aspects of the above embodiments, the alternative shipment specifications may include one or more of an earliest shipment date term, a latest shipment date term, and a preferred shipment term; and may further include one or more alternative shipment terms and a cost difference between each of the alternative shipment terms and the preferred shipment term. Moreover, the system could further perform the step of ranking the bids based on the cost difference.

In accordance with accordance with other aspects of the above embodiments, the alternate shipment specifications may include either a no survayence report is required term or a specific survey report details term. Moreover, the specific survey report details term may include one or more of a packing list survey term, quality certificate term, inspection reports term, survey report specifications term, survey reports topic term, survey locations term, and survey expenses term.

In accordance with a third embodiment of the present invention, a computerized method for providing information to initiators and participants in computerized auctions of products or services is provided which comprising the steps of: maintaining a set of members, the members including buyer members and seller members, the buyer members having the ability to initiate buyer auctions and to participate in seller auctions, the seller members having the ability to initiate seller auctions and to participate in buyer auctions, accepting, from a buyer member, a performance (or qualification) rating for any one of the seller members, accepting, from a seller member, a performance rating for any one of the buyer members, and providing the performance ratings to the set of members.

### BRIEF DESCRIPTION OF THE DRAWINGS

FIGS. 1(a) through 1(c) are a flow chart for an AWMF system in accordance with an illustrative embodiment of the present invention.

FIG. 2 is an illustrative Product Specifications interface for the AWMF system.

FIG. 3 is an illustrative Payment Specifications interface for the AWMF system.

FIG. 4 is an illustrative Shipment Terms interface for the AWMF system.

FIG. 5 is an illustrative Auction Specifications interface for the AWMF system.

FIGS. 6(a) through 6(c) are a flow chart for a bid plus negotiation system in accordance with an illustrative embodiment of the present invention.

FIG. 7 is an illustrative Product Specifications interface for the BPN system

FIG. 8 is an illustrative Payment Specifications interface for the BPN system

FIG. 9 is an illustrative Shipment Terms interface for the BPN system

FIG. 10 is an illustrative Auction Specifications interface for the BPN system

FIG. 11 shows a flow chart for a rating scheme in accordance with an illustrative embodiment of the present invention.

FIG. 12 shows an illustrative rating information interface.

### DETAILED DESCRIPTION OF THE PREFERRED EMBODIMENTS

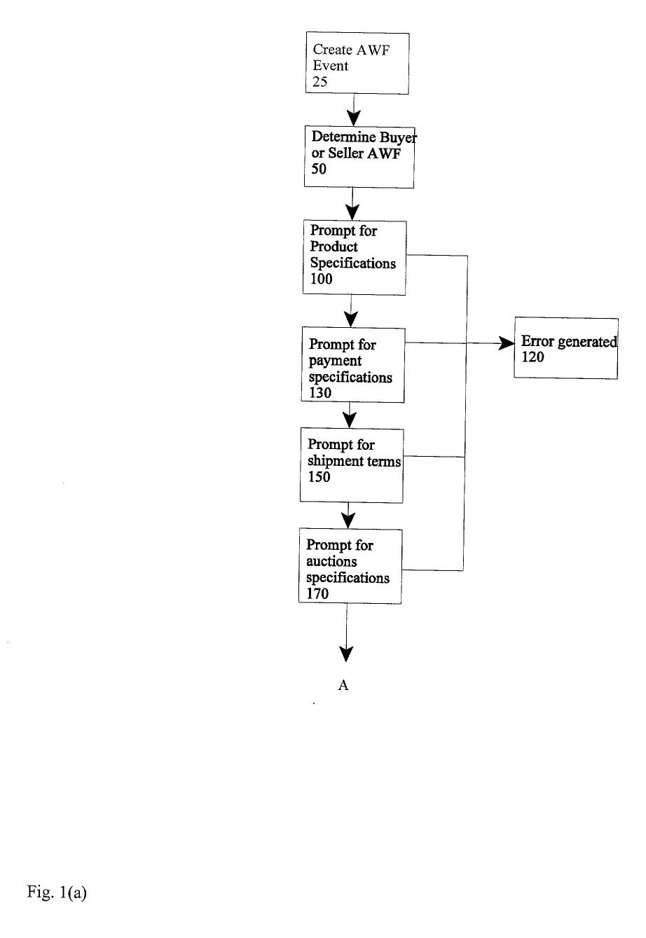

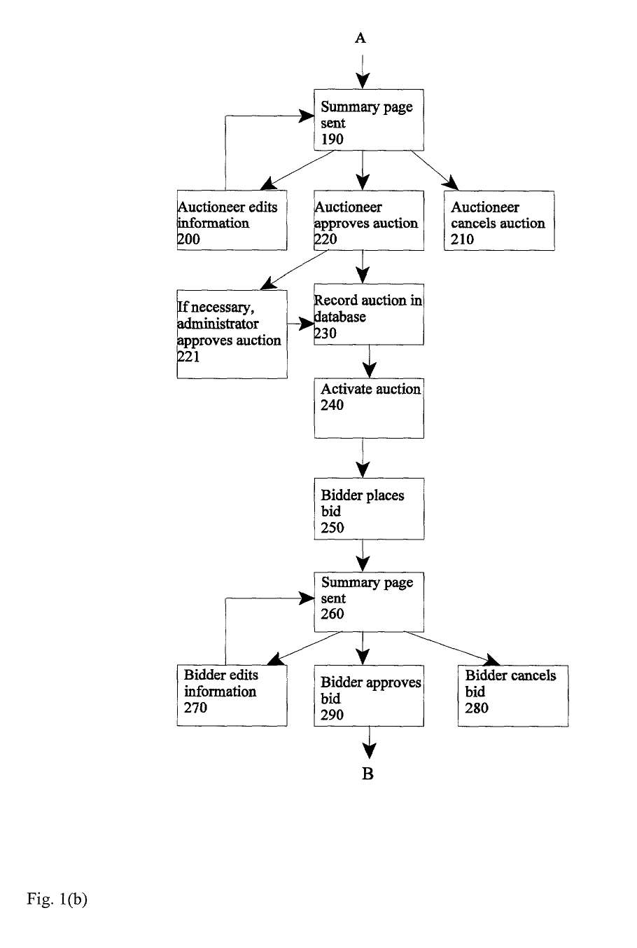

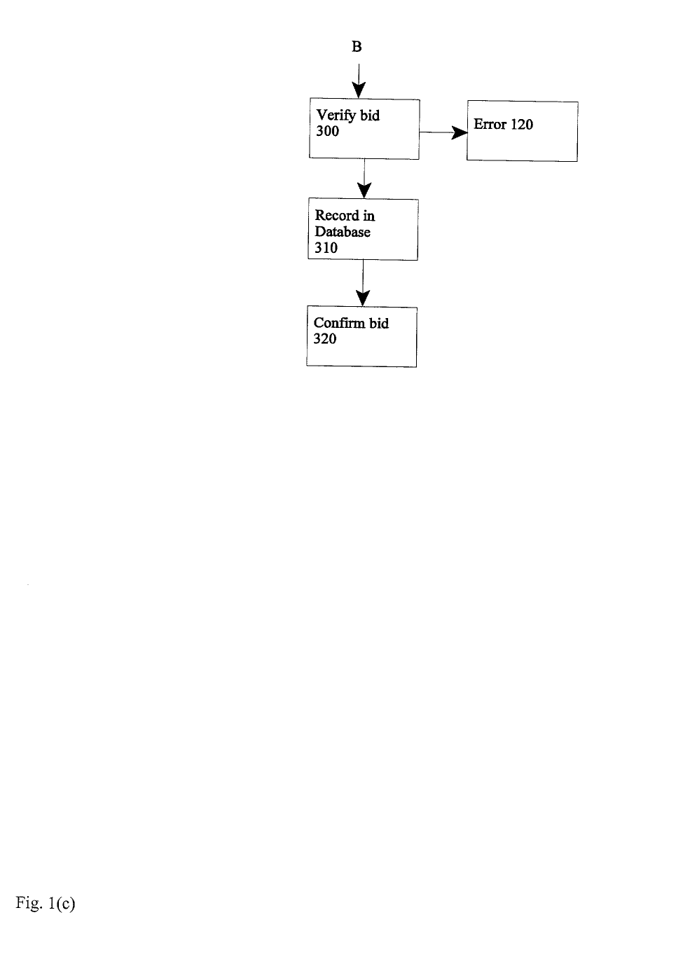

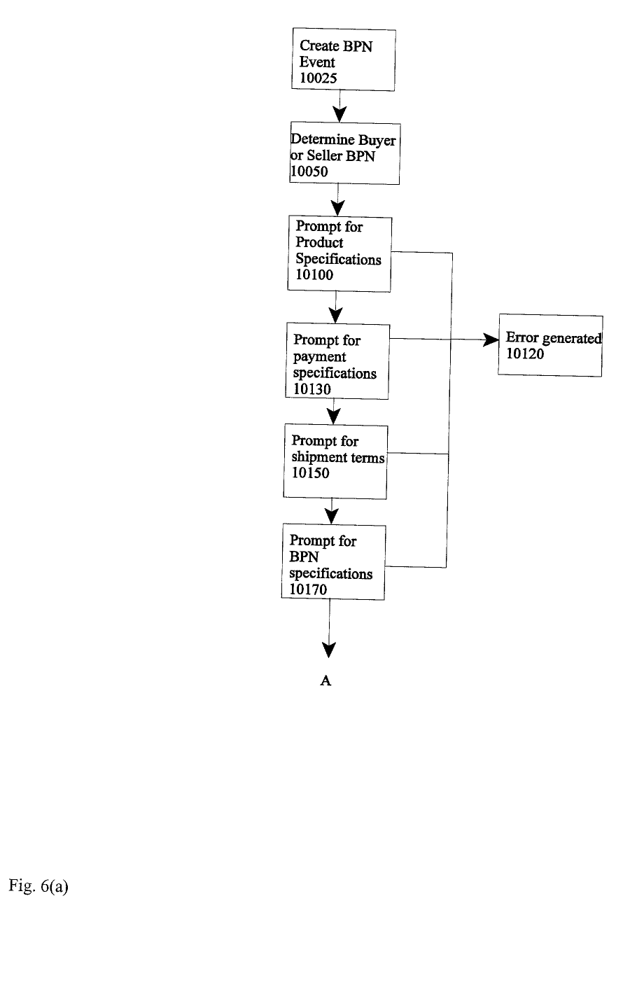

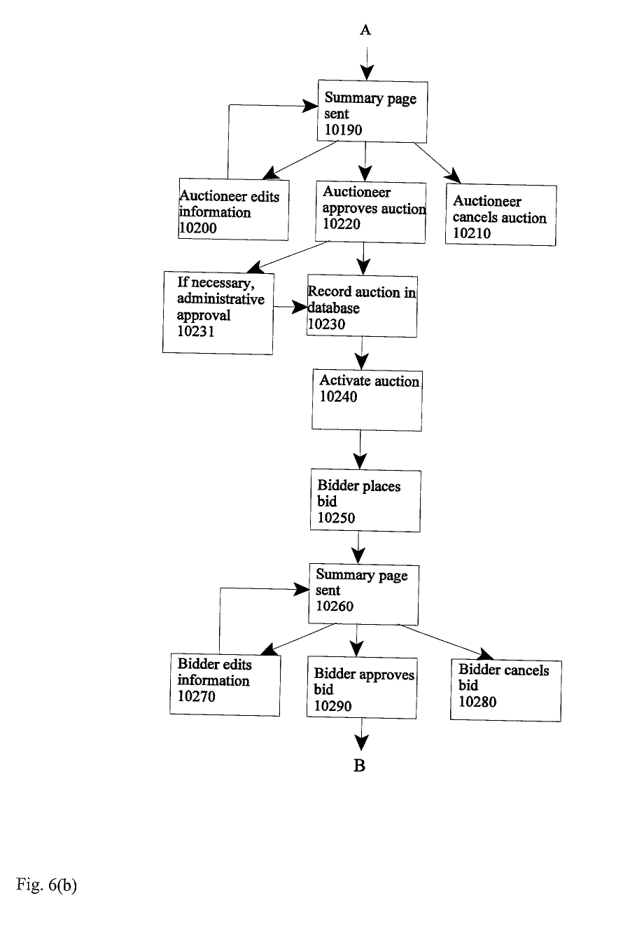

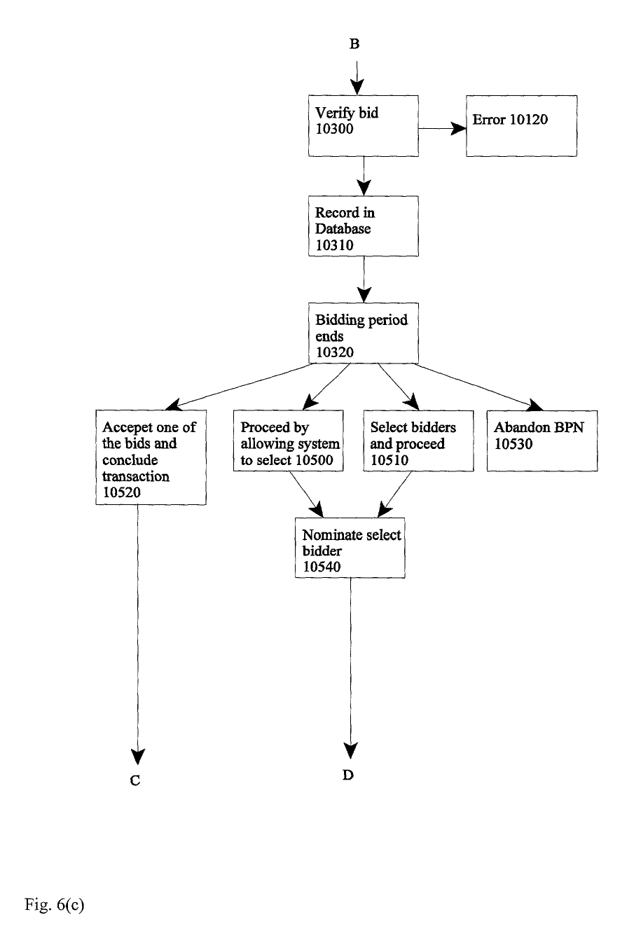

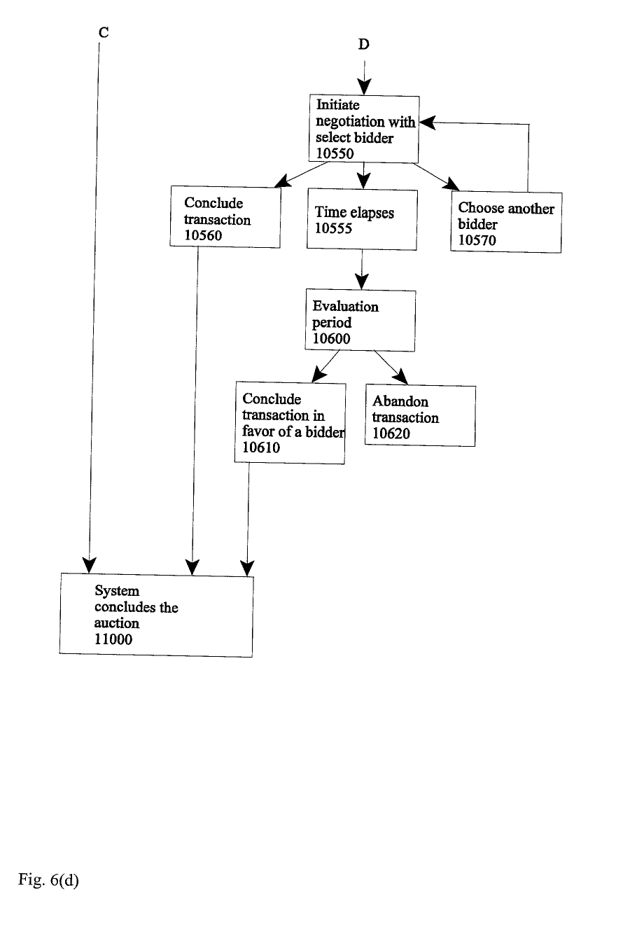

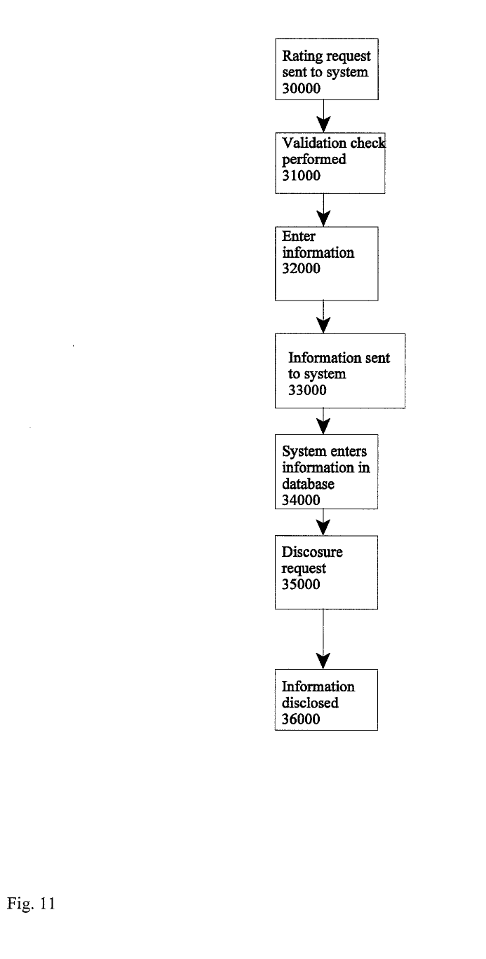

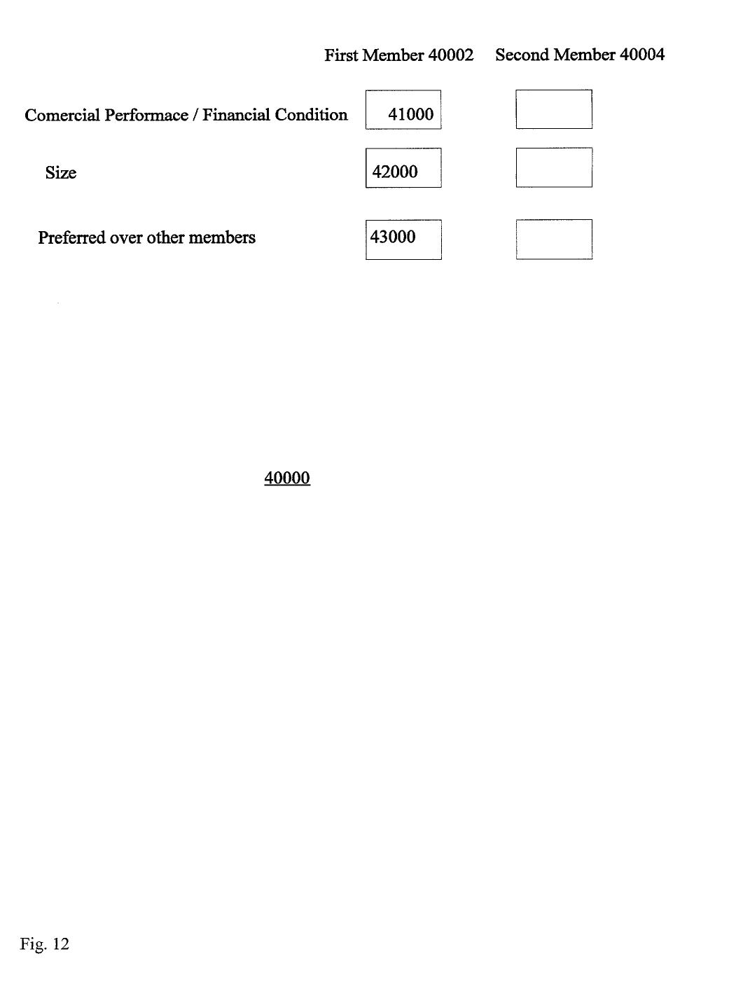

In accordance with a preferred embodiment of the present invention, an electronic auctioning system for members is provided which uses an auction with multiple features model (shown in FIGS. 1-5) and a Bids Plus Negotiation model (shown in FIGS. 6-10) in order to conduct auctions. The system also allows users to rate other users as shown in FIGS. 11-12.

The system uses a Buyer, Trader, Distributer, and Supplier to model participants in exchanges. The buyer is defined as any member who purchases goods through the system for their own consumption and not for resale. The supplier is any member who produces goods traded on the system or an affiliated office associated with the producer member. Also, included in the definition of the supplier is any individual or company that has authority to act as an exclusive agent for the producer member or affiliated office. The Trader is any member who re-sells goods produced or sold by the suppliers on an ex-proforma basis without acting as an exclusive agent (e.g., the supplier issues a proforma invoice to the buyer and buyer opens a letter of credit (L/C) directly to the supplier and the trader is paid a commission. The intermediary between the buyer and seller does not open the L/C.) The distributer is any member who re-sells goods produced/sold by the suppliers on an ex-inventory basis (e.g., sales from inventory) without acting as an exclusive agent (e.g., a seller who maintains a local inventory).

FIG. 1 illustrates the flow of the Auction with multiple features (AWMF) auctioning method. An AWMF is a transaction created by any member in order to buy or sell products. Preferably, any member can design and/or participate in an AWMF auction. On receiving a create AWMF event 25, which can be initiated by a member acting as the buyer, distributer, or supplier, a determination is made as to whether the AWMF is a buyer AWMF or a seller AWMF 50. For example, if the auctioneer is the buyer or distributer, then the AWMF is a buyer AWMF. However, if the auctioneer is the supplier, then the AWMF is a seller AWMF. In the seller AWMF, the seller of a product offers the product to the buyers. However, in the buyer AWMF, the buyer offers to buy a product pursuant to a set of criteria. The buyer's offer is then bid on by sellers.

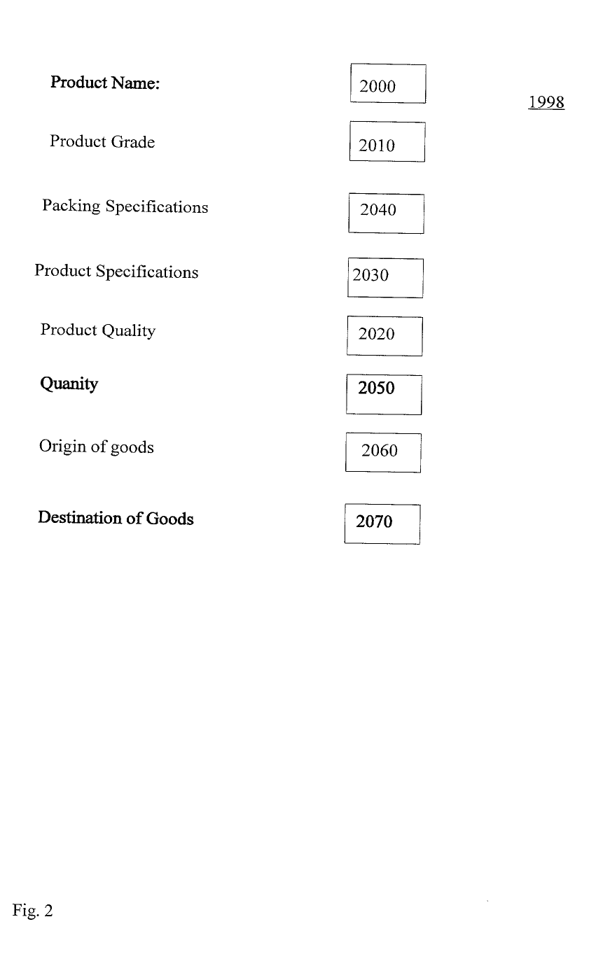

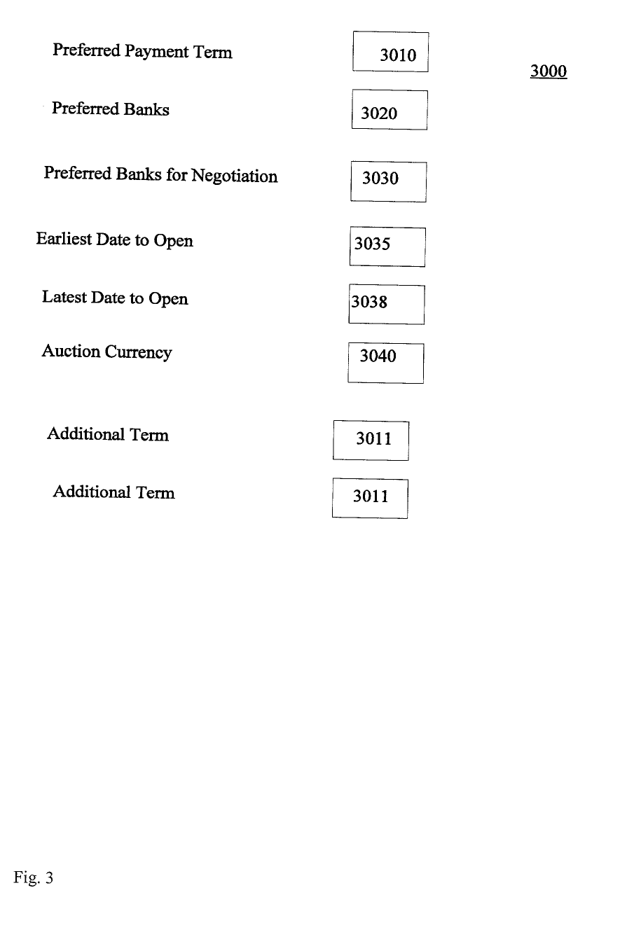

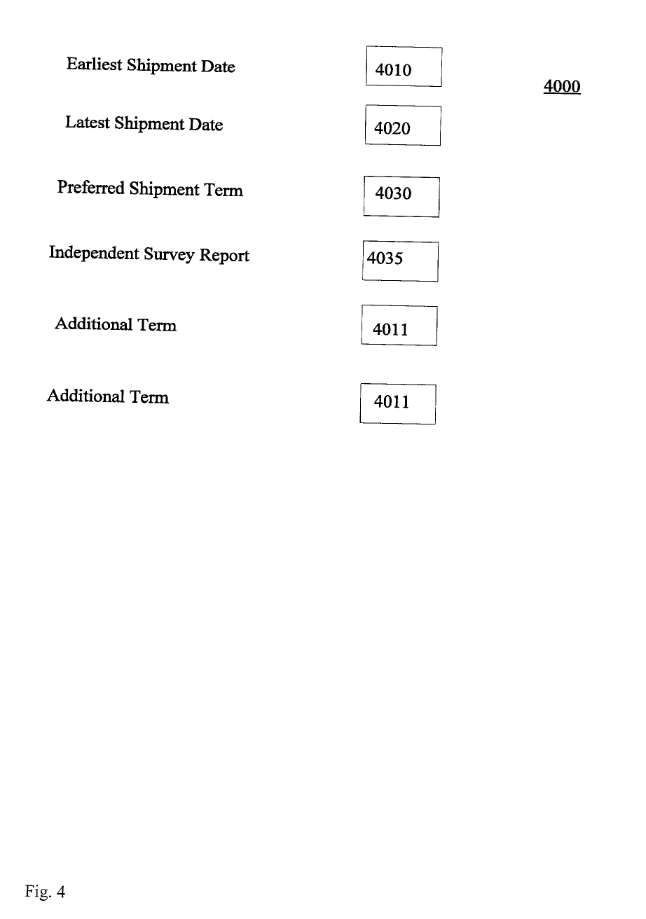

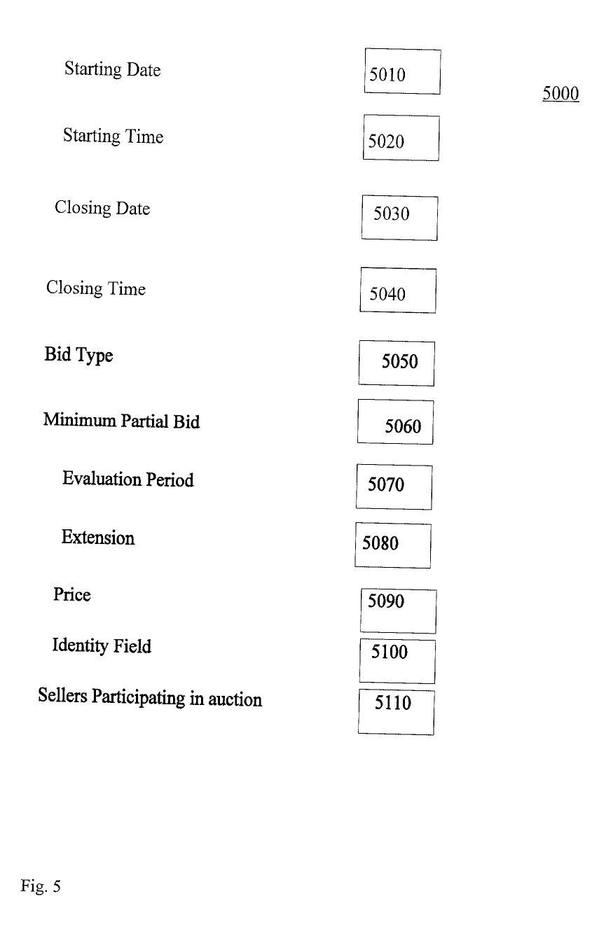

The system then prompts the auctioneer (i.e., the initiator of the AWMF event) for product specification fields (step 100), as shown in FIG. 2. If the system does not receive all the required product specification fields in a specified amount of time, an error is generated (step 120). Otherwise, the system prompts the auctioneer for payment specification fields (step130), as shown in FIG. 3. If the system does not receive all the required payment specification fields in a specified amount of time, an error is generated (step 120). The system then prompts the auctioneer for shipment terms (step 150), as shown in FIG. 4. If the system does not receive all the required shipment terms in a specified amount of time, an error is generated (step 120). Assuming no error is generated, the system prompts the auctioneer for AWMF auction specifications (step 170), as shown in FIG. 5, and if the system does not receive all the required shipment terms in a specified amount of time, an error is generated (step 120).

Once all the required fields have been correctly entered, the system provides the Auctioneer with a summary page of the information submitted (step 190). The Auctioneer may then review and edit the information that was submitted (step 200), cancel the auction (step 210), or approve the auction (step 220). If the auctioneer reviews and edits the information submitted (step 190), the system then provides the auctioneer with an updated summary page that takes into account the edited information (step 190). If the auctioneer has either Administrator user status or knows an authorization code, he or she approves the auction (Step 200). If the auctioneer does not have Administrator user status and does not know the authorization code, then the member may send the AWMF auction to the Administrator user, who can then approve the auction (step221). For example, the member may send the AWMF auction specification to the administrator user by pressing the “send for approval” button. Once the AWMF auction is approved (Step 200, and if necessary Step 221), it is recorded in a database (step 230), and is then activated at the time set by the auctioneer (step 240).

After the AWMF auction is activated (step 240), each bidder can place a bid in the AWMF auction by pressing a “place a bid” button (step 250) that is displayed to the bidder. The “place a bid” button can be on an auction details web page shown to the buyer. In the case of the seller AWMF auction, the bidder is the buyer of a product. However, in the buyer AWMF auction, the bidder is the seller of a product. In the buyer AWMF the trader, distributer, and supplier may participate as the bidder. In the seller AWMF, the buyer, trader, and distributer can participate as the bidder.

If the AWMF is a seller auction, then when placing a bid the bidder selects one of the shipment terms specified by the Auctioneer, one of the payment terms specified by the Auctioneer, and a desired price for the products offered per unit. The desired price may also be as specified without any constraints imposed by the Auctioneer.

If the AWMF is a buyer auction and the bidder is placing a bid for one product with one origin, the bidder selects the name of the county in which the goods are produced, one of the shipment terms specified by the Auctioneer, one of the payment terms specified by the Auctioneer, and a desired price for the products offered per unit. The desired price can be the price as specified by the Auctioneer. Additionally, the bidder may select the name of the manufacturer that is offering the products, and/or the official product code of the products offered.

If the AWMF auction is a buyer auction and the bidder is placing the same bid for different products with different specifications, the bidder selects the name of the county in which the goods are produced, one of the shipment terms specified by the Auctioneer, one of the payment terms specified by the Auctioneer, and a desired price for the products offered per unit. The desired price can be the price as specified by the Auctioneer. Additionally, the bidder may select the name of the manufacturer that is offering the products, and/or the official product code of the products offered. Furthermore, the bidder may select countries of origin for each product offered and/or producers for each product offered. The bidder selects the same shipment terms, payment terms, and desired price for all the products offered. In this way, the bidder may place the same bid for different products with different specifications.

If the AWMF auction is a buyer auction and the bidder is placing a different bid for different products with different specifications, the bidder selects the name of the county in which the goods are produced, one of the shipment terms specified by the Auctioneer, one of the payment terms specified by the Auctioneer, and a desired price for the products offered per unit. The desired price can be the price as specified by the Auctioneer. Additionally, the bidder may select the name of the manufacturer that is offering the products, and/or the official product code of the products offered. Furthermore, the bidder may, for each product offered, select countries of origin, producers, shipment terms, payment terms, desired prices, and product codes. In this way, the bidder may place different bids for different products with different specifications.

The Bidder is then provided with a summary page (step 260) of the information contained in the bid. The Bidder may review and edit the information submitted in previous steps 270, cancel the bid (step 280), or approve the bid (step 290). If the bidder reviews and edits the information submitted, the system then provides the bidder with an updated summary page that takes into account the edited information (step 260).

In order for the bid to be accepted, the system verifies the bid (step 300) by checking the following conditions:

(i) the bidders are authorized to participate in an AWMF seller auction (e.g., they are either a trader, distributor or a buyer);

(ii) the bidders are invited to the auction by the Auctioneer or they have obtained permission from the Auctioneer to place a bid in the auction;

(iii) the bidder's participation is not restricted by the Auctioneer; and

(iv) the bidder has either Administrator user status, knows the correct authorization code, or has the Administrator's approval for the auction.

If any of the above conditions are false, the error is generated (step 120). Once the bid is approved, it is recorded in the database (step 310). Then, once the auction has ended, the bid that the auctioneer selects is confirmed (step 320).

Minimum and maximum auction quotas may be provided by the system. For example, all buyer and distributor members could be required to create at least one buyer AWMF auction every month. Moreover, buyer and distributor members could be barred from creating a second AWMF auction in a given month if they have created and not concluded a first AWMF auction in the same month. Procedures, could, however, be provided to allow a members to create a second AWMF auction if they can state a satisfactory reason for not concluding the first auction. For example, technical difficulties, insufficient number of bids, or unreasonable bids might be considered satisfactory reasons.

FIG. 2 illustrates a Product Specifications interface 1998. The interface includes a Product Name field 2000 which includes the name of the product to be bought or sold in the auction. Also show is a Product Grade field 2010 which refers to the grade of the product to be bought or sold in the auction. The interface also has a Product Quality field 2020 which defines the quality of the product to be bought or sold in the auction. The member can select from three categories of quality: prime, near prime, and offspec. Also included in the interface is a Product Specifications field 2030, which identifies the product specifications. These specifications may include the product code of a manufacturer or other specifications such as Melt Flow Index or K Value. The member may optionally attach a document to further clarify the product specifications.

A Packing Specifications field 2040 refers to the packing specifications of the product to be sold. In this example, there are three packing options the member can choose from: (i) Packed/Bagged, (ii) Packed/Drummed, or (iii) Bulk. It is also possible to make a choice between palletized and non-palletized. The unit used (kg, liter) is generally net. Additional packing requirements can be stated in a free field provided.

A Quantity field 2050 specifies the amount to be sold in the auction. The member may specify the unit of measure, which can include the following; mt, kg, lb, gal, ltr, mg, bbl, cyl, m3, cef, st, mmbtu, dst, ea, bou. The quantity for sale field 2050 is required. If the auction is a buyer AWMF auction, the quantity field 2050 specifies the quantity requested. However, if the auction is a seller AWMF auction, the quantity field 2050 specifies the amount of goods for sale.

An Origin of the goods field 2060 contains the name of the country in which the goods are produced. In an AWMF buyer auction, three options for this field are available to the auctioneer:

(i) open to all countries;

(ii) all countries except the selected ones—in the event that certain countries are not desired as the destination, those countries can be excluded with the help of the arrows from the box where the names of all countries appear; and

(iii) only the selected countries—if trade with certain countries is specifically preferred over the others, then those countries can be included with the help of the arrows from the box where the names of all countries appear.

The interface includes a Destination of the goods field 2070, which is required. The destination of the goods field contains the planned country of sale of the goods. In a seller AWMF auction, three options for this field are available to the auctioneer:

(i) open to all countries;

(ii) all countries except the selected ones—in the event that certain countries are not desired as the destination, those countries can be excluded with the help of the arrows from the box where the names of all countries appear; and

(iii) only the selected countries—if trade with certain countries is specifically preferred over the others, then those countries can be included with the help of the arrows from the box where the names of all countries appear.

FIG. 3 illustrates a Payment Specifications interface 3000. A Preferred Payment Term 3010 includes the preferred way of payment once the transaction is concluded. The following options are available; Payment by letter of credit (“L/C”), which may include from sight to 360 days; cash against documents; cash against goods; open account; wire transfer; check; and cash. The preferred payment term 3010 is required.

The Auctioneer may specify up to two additional payment terms 3011 in addition to the preferred payment term. Bids for different payment terms can then be separately listed for each term.

A Preferred Banks field 3020, which is a required field if L/C is specified in the preferred payment terms 3010 field, refers to the banks with which the Auctioneer prefers to open the L/C. Preferred banks are selected from “Banks” section and added to “Selected Banks” with the help of the arrows. Preferably, selection of multiple banks is made possible by using the “CTRL” key. If the preferred bank is not listed in the box, the Auctioneer may type the name of the bank in a free field.

A Preferred banks for negotiation and confirmation field 3030, which is not required, allows the auctioneer to type the name of a desired bank(s) for negotiation and confirmation.

If the auction is a AWMF buyer auction, an earliest date to open L/C field 3035 is present. The field is required if L/C is specified and allows the Auctioneer to enter the earliest date that the L/C can be opened.

Also shown is a Latest Date to open L/C 3038, which is a required field if L/C is specified in the preferred payment terms field 3010. The Latest date to open L/C 3038 includes the latest date that the winning bidder can open the L/C.

Another required filed is the Auction Currency field 3040. An Auction Currency field 3040 has the currency to be used in the AWMF auction. In the illustrated system, the auctioneer can select from any of the following; USD, EURO, TL, DM, GBP, FF, or JPY.

FIG. 4 illustrates a Shipment Terms interface 4000. An Earliest Shipment Date field 4010 provides for the earliest date for the readiness of the cargo (product) at the port, area, city or border stated under “Port/City” and associated with the preferred shipment term. A Latest Shipment Date 4020 provides for the Latest date for the readiness of the cargo (product) at the port, area, city or border stated under “Port/City” and associated with the preferred shipment term.

The interface also has a Preferred Shipment Term 4030 which allows the auctioneer to choose from the following incoterms; EXW, FAS, FOB, CFR, CIF or CPT (terms refer to the definitions as provided by ICC standards). The auctioneer may also set the preferred port, city and country.

The auctioneer may set additional (up to three) shipment terms 4011, which enable parties to trade in a more flexible environment. The auctioneer states the cost difference between each alternative and the preferred shipment terms. The cost difference is then used by the system to automatically rank the bids for different shipment terms.

If the auction is a AWMF buyer auction, the auctioneer may select an independent survey report 4035. In the report, the auctioneer may choose from the following options:

(i) No surveyance report is required; or

(ii) Specific survey report details.

If the specific survey report details is selected, the auctioneer can then request a packing list survey, quality certificate, inspection reports, survey report specifications, survey report topics, survey locations, and/or survey expenses.

FIG. 5 illustrates an interface for AWMF Auction Specifications 5000. A Starting Date 5010 refers to the date on which the AWMF auction will commence. A Starting Time 5020 contains the time that the AWMF auction will be activated on the given starting date. If the starting time field 5020 is left blank, a default value (e.g., 8 am) is used.

Also shown is a Closing Date 5030, which refers to the date on which the AWMF auction will be closed to further bidding. A Closing Time field 5040 refers to the time when the ongoing AWMF auction will expire on the closing date. If the closing time field 5040 is left blank, a default value (e.g. 6 pm) is used.

A Bid Type field 5050 provides different options for conducting the AWMF auction. The auctioneer may select a (i) Single Bid option, where Bidders bid only once and prices are opaque (i.e., each bidder's price is hidden from the other bidders). Thus, the winning bid is declared after the AWMF auction is finalized. The auctioneer may also select a (ii) Reverse Auction option, whereby bidders can keep bidding until the AWMF auction is closed. A buyer AWMF reverse auction with multiple bids allows for the lowest price from the bidders with the best terms possible.

A Minimum partial bid field 5060, which is not required, is available for a single bid seller or buyer auctions. The auctioneer can accept partial bids from the bidders. However, the auctioneer also declares the minimum amount of the bid that will be acceptable. Thus, bids below the minimum amount are not accepted.

An Evaluation Period field 5070 determines the validity of the offers after the AWMF auction time is over. In this regard, the auctioneer must finalize the AWMF auction within the time range he/she has set in the evaluation period field. Preferably, the time range is not longer than 24 hours.

An Extension field 5080 allows automatic extension of an AWMF auction once the auction time is over, pursuant to a set of conditions. The conditions can be that (i) less than 3 companies participate in the auction; (ii) at least 50% of the bids are placed in the last 5 minutes; and/or (iii) at least 50% of the price improvements take place in the last 5 minutes. Preferably the duration of 5 minutes can be extended to 30 minutes. By choosing, for example, “This auction will not be extended,” the Auctioneer may choose not to extend the auction.

A Price field 5090 allows the auctioneer to choose whether the price offers will be known or anonymous. The auctioneer may choose (i) Prices Known: If prices are known, then every member participating in this AWMF auction will know the prices offered by every bidder. The auctioneer may also chose (ii) Prices Anonymous: If prices are anonymous, the Auctioneer can view all of the prices, but the bidders see just their own prices. In single bid auctions, the default setting of the prices field 5090 is preferably anonymous.

A Participant's Identity field 5100 allows the auctioneer to choose whether the identity of the companies participating in an AWMF auction are known or anonymous by choosing one of the following:

(i) All participants known: The identity of both the Auctioneer and the bidders will be known to all companies participating in that auction.

(ii) All participants anonymous: The identity of both the Auctioneer and the bidders will be anonymous to all parties participating in that auction.

(iii) Parties known, bidders anonymous to peers: The identity of the Auctioneer will be known by all the bidders and the Auctioneer will know all the bidders' identities. However, the bidders will remain anonymous to one another. For example, in a buyer AWMF auction the Auctioneer will know the identity of the sellers and each seller will know the identity of the Auctioneer, however, the bidders will not know whom they are competing against.

A Sellers Participating in the Auction field 5110 allows the auctioneer to decide who can participate in an auction. The selection of the bidders can be done in four ways, as follows. (i) Open to all members: The AWMF auction will be open to all ChemOrbis members and can be viewed by all. (ii) Selected members only, others not allowed: The Auctioneer can limit the participation to only certain members. In this case, the companies to be invited should be selected from the “Members” section and added to “Selected Members” with the help of the arrows. These auctions can only be viewed by those who have the right to participate in that auction. (iii) Selected members only, others with permission: The Auctioneer can limit the participation to only certain members, but may also allow others to participate by seeking his/her permission. In this case, the companies to be invited should be selected from the “Members” section and added to “Selected Members” with the help of the arrows. It is possible to ask for permission simply by clicking on the button “Ask Permission” available in such cases. (iv) Selected members not allowed: The Auctioneer can exclude certain companies, thus these companies will not be able to view the AWMF auction in question.

FIG. 6(a-c) illustrates a flow chart of the Bids plus negotiation (BPN) auctioning method. A BPN is a transaction created by any member in order to buy or sell products. Preferably, all members can design and participate in a BPN auction. On receiving a create BPN event 10025, which can be initiated by a member acting as the buyer, distributer, or supplier, a determination is made as to whether the BPN is an buyer BPN or a seller BPN 10050. For example, if the auctioneer is the buyer or distributer, then the BPN is a buyer BPN. However, if the auctioneer is the supplier, then the BPN is a seller BPN. In the seller BPN, the seller of a product offers the product to the buyers. However, in the buyer BPN, the buyer offers to buy a product pursuant to a set of criteria. The buyers offer is then bid on by sellers.

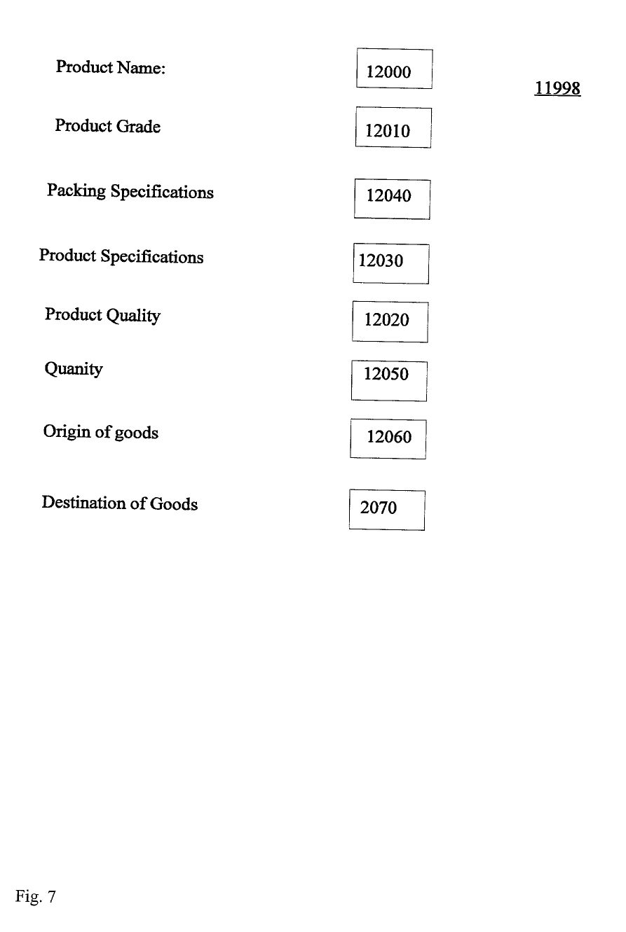

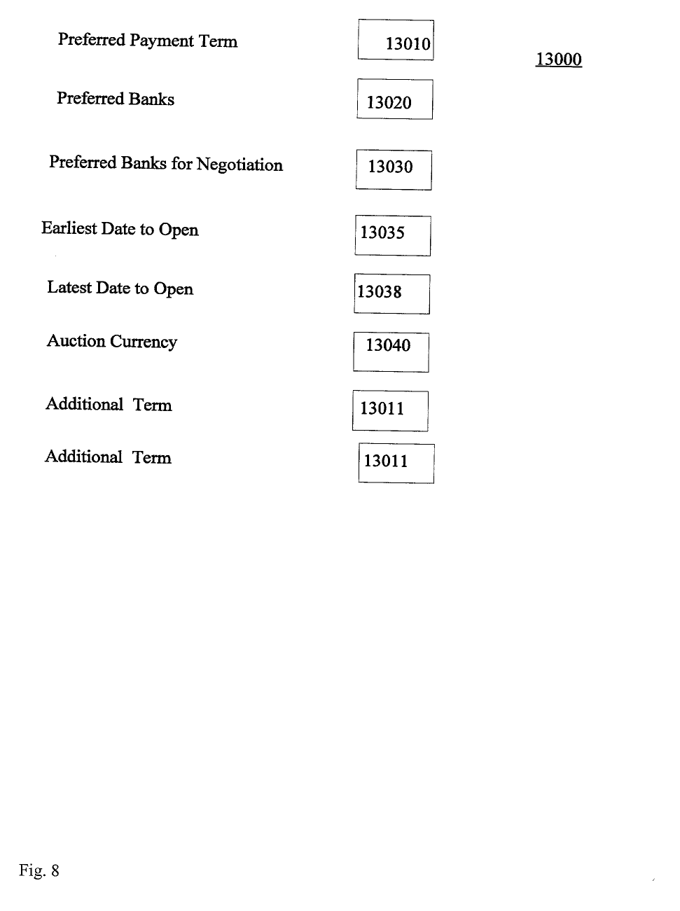

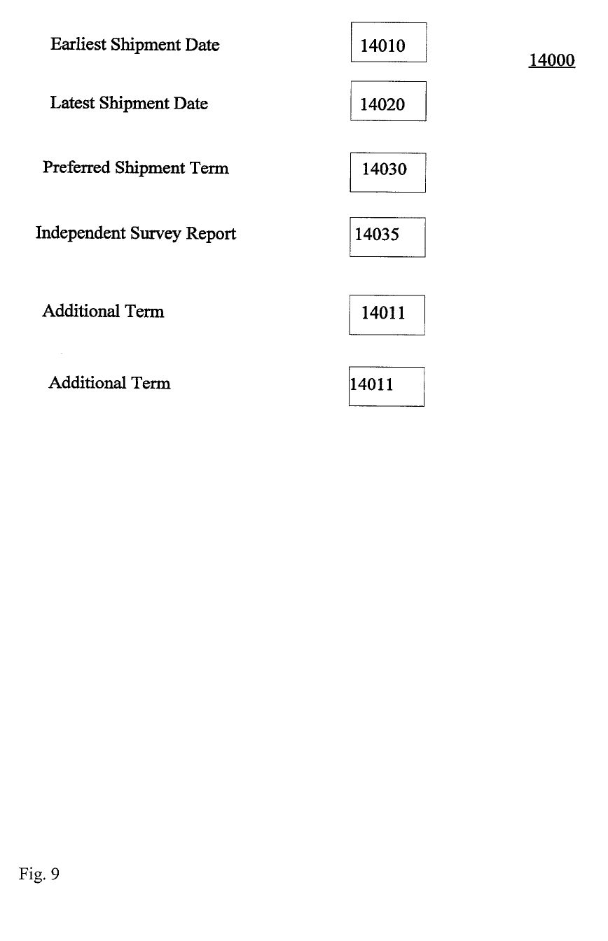

The system then prompts the auctioneer (i.e., the initiator) for BPN product specification fields (step 10100), as shown in FIG. 7. If the system does not receive all the required BPN product specification fields in a specified amount of time, an error is generated (step 10120). Otherwise, the system prompts the auctioneer for BPN payment specification fields (step 10130), as shown in FIG. 8. If the system does not receive all the required BPN payment specification fields in a specified amount of time, an error is generated (step 10120). If it does, the system prompts the auctioneer for BPN shipment terms (step 10150), as shown in FIG. 9. If the system does not receive all the required BPN shipment terms in a specified amount of time, an error is generated (step 10120). Assuming the system does receive the required fields, the system prompts the auctioneer for BPN specifications (step 10170), as shown in FIG. 5, and if the system does not receive all the required BPN specifications in a specified amount of time (step 10180), an error is generated (step 10120).

After receiving all the required fields, the system provides the auctioneer with a BPN summary page of the information submitted (step 10190). The Auctioneer may then review and edit the information that was submitted (step 10200), cancel the auction (step 10210), or approve the auction (step 10220). If the auctioneer reviews and edits the information submitted (step 10200), the system then provides the auctioneer with an updated summary page that takes into account the edited information (step 10190). Preferably, to approve the auction, the member has either Administrator user status or knows an authorization code. If the member is not the Administrator user and does not know the authorization code, then the member may send the BPN auction to the Administrator user, who can then approve the auction (step 10231). For example, the member may send the BPN auction specification to the administrator user by pressing the “send for approval” button.

Once the BPN auction is approved, it is recorded in a database (step 10230), and is then activated at the time set by the auctioneer (step 10240).

After the BPN auction is activated (step 10240), each bidder can place a bid in the BPN auction by pressing a “place a bid” button (step 10250) that is displayed to the bidder. The bidder can place one or more bids up to a maximum limit. Preferably, the maximum limit is set at three. Subsequent bids by the same bidder, which can be either higher or lower, nullify prior bids of the bidder. The “place a bid” button can be on an auction details web page shown to the buyer. In the case of the BPN seller auction, the bidder is the buyer of a product. However, in the BPN buyer auction, the bidder is the seller of the product. The bidder can be the trader, distributer, or supplier in the buyer BPN. Either a buyer or a distributer may initiate the BPN buyer auction. In the seller BPN, the bidder can be the buyer, trader, or distributer, and the supplier initiates the auction.

If the BPN is a seller auction, then when placing a bid the bidder selects one of the shipment terms specified by the Auctioneer, one of the payment terms specified by the Auctioneer, and a desired price for the products offered per unit. The desired price can be the price as specified by the Auctioneer.

If the BPN is a buyer auction and the bidder is placing a bid for one product with one origin, when placing the bid the bidder selects the name of the county in which the goods are produced, one of the shipment terms specified by the Auctioneer, one of the payment terms specified by the Auctioneer, and a desired price for the products offered per unit. The desired price can be the price as specified by the Auctioneer. Additionally, the bidder may select the name of the manufacturer that is offering the products, and/or the official product code of the products offered.

If the BPN auction is a buyer auction and the bidder is placing the same bid for different products with different specifications, the bidder selects the name of the county in which the goods are produced, one of the shipment terms specified by the Auctioneer, one of the payment terms specified by the Auctioneer, and a desired price for the products offered per unit. Additionally, the bidder may select the name of the manufacturer that is offering the products, and/or the official product code of the products offered. Furthermore, the bidder may select countries of origin for each product offered and/or producers for each product offered. The bidder selects the same shipment terms, payment terms, and desired price for all the products offered. In this way, the bidder may place the same bid for different products with different specifications.

If the BPN auction is a buyer auction and the bidder is placing a different bid for different products with different specifications, the bidder selects the name of the county in which the goods are produced, one of the shipment terms specified by the Auctioneer, one of the payment terms specified by the Auctioneer, and a desired price for the products offered per unit. Additionally, the bidder may select the name of the manufacturer that is offering the products, and/or the official product code of the products offered. Further more, the bidder may, for each product offered, select countries of origin, producers, shipment terms, payment terms, desired prices, and product codes. In this way, the bidder may place different bids for different products with different specifications.

The Bidder is then provided with a summary page (step 10260) of the information contained in the bid. The Bidder may review and edit the information submitted in previous steps 10270, cancel the bid (step 10280), or approve the bid (step 10290). If the bidder reviews and edits the information submitted (step 10270), the control module then provides the bidder with an updated summary page that takes into account the edited information (step 10260).

In order for the bid to be accepted, the system verifies the bid (step 10300) by checking the following conditions:

(i) the bidders are authorized to participate in an BPN seller auction (e.g., they are either a trader, distributor or a buyer);

(ii) the bidders are invited to the auction by the Auctioneer or they have obtained permission from the Auctioneer to place a bid in the auction;

(iii) the bidder's participation is not restricted by the Auctioneer; and

(iv) the bidder has either Administrator user status, knows the correct authorization code, or has the Administrator's approval for the auction.

If any of the above conditions are false, the error is generated (step 10120). Once the bid is approved, it is recorded in the database (step 10310).

At the end of the initial bidding period (step 10320) (e.g., the time limit set for the bidding period has expired), the auctioneer selects one of the following:

(i) proceed to the next step with the bidders selected by the system (step 10500);

(ii) select a plurality of bidders and proceed to the next phase (step 10510);

(iii) accept one of the bids (step 10520); or

(iv) abandon the BPN (step 10530).

Preferably, the maximum number of bidders that can be selected is three. Also, if the BPN is abandoned, a fine can be imposed on the auctioneer (e.g., U.S. $250). The auctioneer may allow the system to select the three best bidders (e.g., in order of their best price bidder status) or the auctioneer may rank the bidders and nominate any of the bidders to start negotiation phase.

Next, one of the bidders becomes the select bidder 10540. The bidder with the best price bidder status or one of the bidders nominated by the auctioneer becomes the selected bidder.

The auctioneer then initiates the negotiation with the select bidder 10550, whereby the auctioneer and select bidder then each make additional sequential firm bid/counter bids to negotiate and agree on the price payment and other contract terms deemed appropriate. Preferably, the auctioneer and each bidder may make two additional firm bid/counter bids. During the additional firm bid/counter bids, the auctioneer and the bidder may agree on the terms at any time during the process. Preferably, all other bidders except the selected bidder are held pending while this negotiation is continuing. The time between each bid/counter bid may be set to a maximum of 5 minutes. Preferably, each bidder sets an expiration time for their bids. Preferably, the system requires a minimum expiration time of, for example, 30 minutes. The auctioneer and the bidder may repeat their prices in each bid or counter bid.

At the end of the negotiation with the first qualified bidder, the auctioneer can choose the bidder and conclude the BPN transaction (step 10560) or choose another bidder as the select bidder (step 10570).

If the auctioneer chooses another bidder as the select bidder, the bidder can then make his last counter bid valid until the end of the BPN transaction or may set a validity period for the counter-bid up to a maximum time (e.g., 30 minutes). The method then returns to the negotiation with the select bidder (step 10550).

If after a specified time has elapsed and the BPN is still not concluded (step 10555), the parties then proceed to the evaluation period (step 10600). Preferably, the evaluation period cannot last more than 1 hour. When the evaluation period is over, the auctioneer either (i) concludes BPN transaction in favor of any of the bidders (step 10610) or (ii) abandons the transaction (step 10620). Preferably, if the transaction is abandoned, the auctioneer pays a fine (e.g., US$ 500) to the system. Once the bid is confirmed, the system concludes the auction (step 11000).

FIG. 7 illustrates the BPN Product Specifications interface 11988. The interface includes a Product Name field 12000, which includes the name of the product to be bought or sold in the auction. Also show is a Product Grade field 12010, which refers to the grade of the product to be bought or sold in the auction. The interface also has a Product Quality field 12020, which defines the quality of the product to be bought or sold in the auction. The member can select from three categories of quality; prime, near prime, and offspec.

Also included in the interface is a Product Specifications field 12030, which identifies the product specifications. These specifications may include the product code of a manufacturer or other specifications such as Melt Flow Index or K Value. The member may optionally attach a document to further clarify the product specifications.

A Packing Specifications field 12040 identifies the packing specifications of the product to be sold. There are three packing options the member can choose from are: (i) Packed/Bagged, (ii) Packed/Drummed, or (iii) Bulk. It is also possible to make a choice between palletized and non-palletized. Preferably, the unit used (kg, liter) is net. Additional packing requirements can be stated in a free field provided.

A Quantity field 12050 specifies the amount to be sold in the auction. The member may specify the unit of measure, which can include the following; mt, kg, lb, gal, ltr, mg, bbl, cyl, m3, ccf, st, mmbtu, dst, ea, bou. If the auction is a buyer BPN auction, the quantity field 12050 specifies the quantity requested. However, if the auction is a seller BPN auction, the quantity field 12050 specifies the amount of goods for sale.

An Origin of the goods field 12060 contains the name of the country in which the goods are produced. In an BPN buyer auction, three options for this field are available to the auctioneer:

(i) open to all countries;

(ii) all countries except the selected ones—in the event that certain countries are not desired as the destination, those countries can be excluded with the help of the arrows from the box where the names of all countries appear; and

(iii) only the selected countries—if trade with certain countries is specifically preferred over the others, then those countries can be included with the help of the arrows from the box where the names of all countries appear.

The interface includes a Destination of the goods field 12070, which contains the planned country of sale of the goods. In a seller BPN auction, three options for this field are available to the auctioneer:

(i) open to all countries;

(ii) all countries except the selected ones—in the event that certain countries are not desired as the destination, those countries can be excluded with the help of the arrows from the box where the names of all countries appear; and

(iii) only the selected countries—if trade with certain countries is specifically preferred over the others, then those countries can be included with the help of the arrows from the box where the names of all countries appear.

FIG. 8 illustrates a BPN Payment Specifications interface 13000. A Preferred Payment Term 13010 includes the preferred way of payment once the transaction is concluded. The following options are available; Payment by letter of credit (“L/C”), which may include from sight to 360 days; cash against documents; cash against goods; open account; wire transfer; check; and cash.

The Auctioneer may specify up to two additional payment terms 13011 in addition to the preferred payment term. Bids for different payment terms are then separately listed for each term.

A Preferred Banks field 13020, which is required field if L/C is specified in the preferred payment terms 13010 field, refers to the banks with which the Auctioneer prefers to open the L/C. Preferred banks are selected from a “Banks” section and added to a “Selected Banks” with the help of the arrows. Preferably, selection of multiple banks is possible by using the “CTRL” key. If the preferred bank is not listed in the box, the Auctioneer may type the name of the bank in a free field.

A Preferred banks for negotiation and confirmation field 13030, which is not required, allows the auctioneer to type the name of a desired bank(s) for negotiation and confirmation.

If the auction is a BPN buyer auction, an earliest date to open L/C field 13035 is present. The field is required if L/C is specified and allows the Auctioneer to enter the earliest date that the L/C can be opened.

Also shown is a Latest Date to open L/C, which is a required field if L/C is specified in the preferred payment terms field 13010. The field includes the latest date that the winning bidder can open the L/C.

Another required filed is the Auction Currency field 13040. The Auction Currency field 3040 has the currency to be used in the BPN auction. The auctioneer can select from any of the following; USD, EURO, TL, DM, GBP, FF or JPY.

FIG. 9 illustrates a Shipment Terms interface 14000. An Earliest Shipment Date field 14010 provides for the earliest date for the readiness of the cargo (product) at the port, area, city or border stated under “Port/City” and associated with the preferred shipment term. A Latest Shipment Date 14020 provides for the Latest date for the readiness of the cargo (product) at the port, area, city or border stated under “Port/City” and associated with the preferred shipment term.

The interface also has a Preferred Shipment Term 14030, which allows the auctioneer to choose from the following incoterms; EXW, FAS, FOB, CFR, CIF or CPT (terms refer to the definitions as provided by ICC standards). The auctioneer may also set the preferred port, city and country.

The auctioneer may set additional (up to three) shipment terms 14011, which enable parties to trade in a more flexible environment. The auctioneer states the cost difference between each alternative and the preferred shipment terms. The cost difference is then used by the system to automatically rank the bids for different shipment terms.

If the auction is a BPN buyer auction, the auctioneer may select an independent survey report 14035. In the field, the auctioneer may choose from the following options:

(i) No surveyance report is required; or

(ii) Specific survey report details.

If the specific survey report details is selected, the auctioneer can then request a packing list survey, quality certificate, inspection reports, survey report specifications, survey report topics, survey locations, and/or survey expenses.

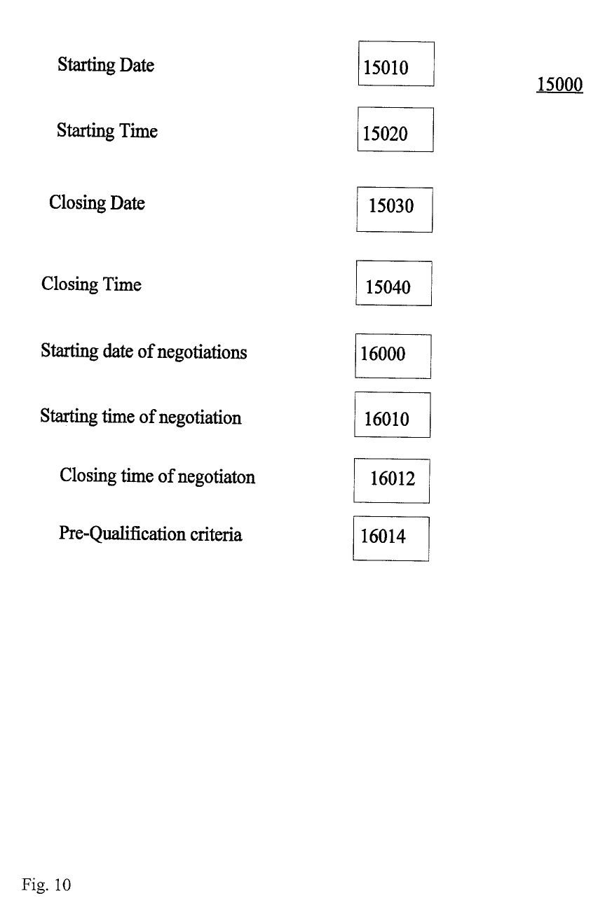

FIG. 10 illustrates the interface for an BPN Auction Specifications 15000. A Starting Date 15010 refers to the date on which the AWMF auction will commence. A Starting Time 15020 contains the time that the AWMF auction will be activated on the given starting date. If the starting time field 15020 is left blank, a default value (e.g., 8 am) is used. Also shown is a Closing Date 15030, which is required. The closing date 15030 refers to the date on which the AWMF auction will be closed to further bidding.

A Closing Time field 15040 refers to the time when the ongoing BPN auction will expire on the closing date. If the closing time field 15040 is left blank, a default value (e.g., 6 pm) is used.

A starting date negotiation phase field 16000 refers to the date on which the Negotiation phase of the buyer BPN commences.

A starting time negotiation phase field 16010 contains the time that the negotiation phase of the BPN auction will be activated on the given starting date. If the field 16010 is left blank, a default value (e.g., 8 AM is used).

A closing time negotiation phase field 16012 contains the time that the negotiation phase of the BPN auction will be activated on the given starting date. Preferably, the closing time negotiation phase field 16012 can not be set to less than one hour after the starting time of the negotiation phase.

A Pre-qualification criteria field 16014 defines which three bidders will qualify to the negotiation phase once the bidding phase is completed. Two different criteria may be set for the pre-qualification field 16014:

(i) Price only (top three prices will be selected automatically by the system); and

(ii) Auctioneer selects three bidders (after bids phase closes within 15 minutes of this closure).

FIG. 11 shows a flow chart of a rating scheme in accordance with one aspect of the present invention. The rating scheme enables Members to evaluate other members without knowing the identity of the other members and thus, confidently trade.

If a Member wishes to rate other members, the member sends a rating request to the system (step 30000). If the member chooses not to rate an other member, the other member is assigned a rating of average (i.e, 3 for the first rate category and 2 for the second and third rate categories).

Next, a validation check (step 31000) is performed, in order to ensure that the member is allowed to rate the other member. The following table shows who can rate whom.

| | | | |
|---|---|---|---|
| Buyer | Trader | Distributor | Supplier |

| | | | | |
|---|---|---|---|---|
| Buyer | Cannot Rate | Can Rate | Can Rate | Can Rate |
| Trader | Can Rate | Cannot Rate | Can Rate | Can Rate |
| Distributor | Can Rate | Can Rate | Can Rate | Can Rate |
| Supplier | Can Rate | Can Rate | Can Rate | Cannot Rate |

For example, the supplier can rate the buyer, trader, and distributer; however, the supplier cannot rate other suppliers. Additionally, administrator users can use the rating feature on behalf of the company of the administrator. Preferably, members are permitted to revise their rate for any other member only once a day.

If the member is allowed to rate the other member, the member enters the rating information through a rating interface 32000, as shown in FIG. 12.

The member then sends the information to the system (step 33000) (e.g., by clicking a “send information button”), and the system enters the information into a database (step 34000).

The information in the database can then be disclosed (step 36000) to any member upon a request (step 35000) by the said member.

FIG. 12 shows an interface for entering the rating information 40000. Preferably, one or more members can be evaluated in the interface for entering rating information 40000. An evaluation profile for a first member 40002 and second member 40004 are shown.

A Commercial performance and financial condition category 41000 allows the member to enter the following ratings:

“1”—Excellent performance, financial condition, problem resolution;

“2”—Good performance, financial condition, problem resolution;

“3”—member has some concerns about performance, financial conditions and problem resolution;

“4”—Unknown (the member has no knowledge of the member that is being rated); and

“5”—Unacceptable.

When a member receives an unacceptable rating, the system may, for example, automatically guarantee that the member reviewing the rating does not participate in any auctions of the member giving the rating.

A size category 42000 allows the member to enter the following ratings:

“1”—Large;

“2”—Medium; and

“3”—Small.

A preference over the other members 43000 category allows the member to enter the following:

“1”—Highly Preferred;

“2”—Indifferent; and

“3”—Not Preferred.

Preferably, in using the interface 40000, members will see a list of all members that they have the authorization to rate, along with any previous ratings that the member has given them. In any actions where the participants identities are anonymous, the rating of each anonymous participant will appear as three digit numbers, for example, “1.2.1.” In this example, the “1.2.1” means that the particular member has excellent performance, financial condition, problem resolution (“1” as the first digit); is medium sized (“2” as the second digit); and is highly preferred (“3” as the third digit).

Preferably, the member communicates with the system by a client-server architecture, wherein the member is a client and the system is a server. Most preferably, the client-server architecture operates over the Internet. For example, the member enters fields on a web page, and then submits the fields to the system.

The member may communicate with the system by a direct connection (e.g., a direct internet connection such as TELNET). However, the member could also communicate withe the system by an indirect connection. For example, the user could correspond with the system by mail or could submit fields by pressing a send button on a web page.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computerized method for auctioning products or services, comprising the steps of:
maintaining a set of members, the members including a plurality of buyers of products and/or services and a plurality of sellers of products and/or services;
initiating a seller auction in response to a request from one of the plurality of sellers, the request including product/service specifications for a product/service which the seller wishes to sell, a set of alternative payment specifications acceptable to the seller, a set of alternative shipment term specifications acceptable to the seller, and an auction specification;
in response to the initiation of the seller auction, receiving one or more bids from a corresponding one or more of the plurality of buyers, each bid identifying one of the set of alternative payment specifications acceptable to the seller, one of the set of alternative shipment specifications acceptable to the seller, and a desired price for the product/service identified by the product/service specifications;
for each of the one or more bids, verifying that the bid is from an authorized one of the plurality of buyers based upon the auction specification;
receiving, from the seller, either an acceptance of one of the authorized bids or a rejection of all authorized bids;
initiating a buyer auction in response to a request from one of the plurality of buyers, the request including product/service specifications for a product/service which the buyer wishes to purchase, a set of alternative payment specifications acceptable to the buyer, a set of alternative shipment term specifications acceptable to the buyer, and an auction specification;
in response to the initiation of the buyer auction, receiving one or more bids from a corresponding one or more of the plurality of seller, each bid identifying one of the set of alternative payment specifications acceptable to the buyer, one of the set of alternative shipment specifications acceptable to the buyer, and a desired price for the product/service identified by the product/service specifications;
for each of the one or more bids, verifying that the bid is from an authorized one of the plurality of sellers based upon the auction specification; and
receiving, from the buyer, either an acceptance of one of the authorized bids or a rejection of all authorized bids.

2. The method of claim 1, wherein the product specifications include one or more of a product name, a product grade, packing specifications, product specifications, product quality, product quantity, origin of goods, and destination of goods.

3. The method of claim 1, wherein the set of payment specifications include one or more of a preferred payment term, a set of preferred banks, a preferred set of banks for negotiation, an earliest date to open, a latest date to open, and an auction currency.

4. The method of claim 1, wherein the set of alternative shipment specifications include one or more of an earliest shipment date, a latest shipment date, a preferred shipment term.

5. The method of claim 1, wherein the auction specifications for a buyer auction include an identification of sellers authorized to bid.

6. The method of claim 1, wherein the auction specifications for a buyer auction include an identification of buyers authorized to bid.

7. A computerized method for auctioning products or services, comprising the steps of:
initiating an auction in response to a request from an auctioneer;
in response to the initiation of the auction, receiving one or more bids from a corresponding one or more bidders;
selecting a plurality of the bidders to form a final bidders set;
designating, in turn, each one of bidders of the final bidders set as the select bidder until one of an acceptance of a bid from one of the final bidders and a rejection of all bids from each of the final bidders occurs;
for each select bidder,
sending one or more bidder bids from the select bidder to the auctioneer;
sending one or more auctioneer bids from the auctioneer to the select bidder; and
receiving one of an agreement on a current bid or a termination of bidding from one of the auctioneer and the select bidder.

8. The method of claim 7, wherein the auctioneer is a seller of goods or services.

9. The method of claim 7, wherein the auctioneer is a buyer of goods or services.

10. The method of claim 7, wherein the request includes product/service specifications for a product/service which the auctioneer wishes to sell or buy, a set of alternative payment specifications acceptable to the auctioneer, a set of alternative shipment term specifications acceptable to the auctioneer; and
wherein each bid identifies one of the set of alternative payment specifications acceptable to the auctioneer, one of the set of alternative shipment specifications acceptable to the auctioneer, and a desired price for the product/service identified by the product/service specifications.

11. The method of claim 10, wherein the request from the auctioneer includes an auction specification, and wherein the method further comprises the step of
for each of the one or more bids, verifying that the bid is from an authorized bidder based upon the auction specification.

12. A computerized method for providing information to initiators and participants in computerized auctions of products or services, comprising the steps of:
maintaining a set of members, the members including buyer members and seller members, the buyer members having the ability to initiate buyer auctions and to participate in seller auctions, the seller members having the ability to initiate seller auctions and to participate in buyer auctions;
accepting, from a buyer member, a performance rating for any one of the seller members;
accepting, from a seller member, a performance rating for any one of the buyer members;
providing the performance ratings to the set of members.

13. The method of claim 1, wherein the alternative payment specifications includes two or more of a payment by letter of credit term, cash against documents term, cash against goods term, open account term, wire transfer term, check term, a cash term, and an auction currency term.

14. The method of claim 1, wherein the product/service specifications includes two or more of a packed/bagged term, packed/drummed term, bulk term, palletized term, non-palletized term, and user defined packing term.

15. The method of claim 1, wherein the alternative shipment specifications includes one or more of an earliest shipment date term, a latest shipment date term, and a preferred shipment term.

16. The method of claim 15, wherein the alternative shipment specifications includes one or more alternative shipment terms and further includes a cost difference between each of the alternative shipment terms and the preferred shipment term.

17. The method of claim 16, further including the step of ranking the bids based on the cost difference.

18. The method of claim 1, wherein the product/service specifications includes two or more of an open to all countries term, all countries except a selected one term, and only the selected countries term.

19. The method of claim 1, wherein the alternate shipment specifications includes either a no survayence report is required term or a specific survey report details term.

20. The method of claim 19, wherein the specific survey report details term includes one or more of a packing list survey term, quality certificate term, inspection reports term, survey report specifications term, survey reports topic term, survey locations term, and survey expenses term.
